(19) United States
(12) Patent Application Publication
(10) Pub. No.: US 2006/0244397 A1
(43) Pub. Date: Nov. 2, 2006

(54) Horizontal raster centering circuit for a projection television receiver

(75) Inventor: Steve Golik, Knoxville, TN (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/565,661

(22) PCT Filed: Jul. 20, 2004
(86) PCT No.: PCT/IB04/51265

§ 371 Date: Jan. 23, 2006

Related U.S. Application Data
(60) Provisional application No. 60/489,627, filed on Jul. 24, 2003.

(51) Int. Cl. H01J 29/70

(52) U.S. Cl. 315/364

(57) ABSTRACT

Abstract: A horizontal raster centering circuit for a projection television receiver includes a single inductor positioned across the horizontal deflection coils of the three cathode ray tubes to provide equal, yet opposite polarity currents which are steered by diodes into two of the AC coupled horizontal deflection yokes to provide raster centering with a minimum of components and with little power dissipation in the circuit.

The subject invention relates to projection television receivers and to circuits for centering a picture on the screen of the projection television receiver.

In a television receiver using a cathode ray tube (CRT), horizontal and deflection yoke currents are produced to create magnetic fields in deflection coils mounted on the neck of the CRT in order to deflect an electron beam. The deflection yoke has two separate sets of windings, the horizontal and vertical windings, to control the movement of the electron beam in both the x and y axes on the face of the CRT. The electron beam is produced by a heated cathode element in the neck of the CRT and the electrons in the beam are accelerated toward the face of the CRT by a high voltage at the anode element of the CRT. At the face of the CRT, there is a thin coating of a phosphor material which glows for a brief period of time when struck by the electron beam. As this beam is deflected across the face of the CRT, it is modulated in level intensity to produce areas of varying brightness intensity, thus forming an image on the face of the CRT. This resulting image is called a raster.

To produce a colored raster, three separate intensity-controlled cathode elements are used in conjunction with three different colored phosphor materials, i.e., red green and blue, in order to produce the full spectrum of colors.

In a projection television receiver (PTV), there are three separate CRT's each with only one cathode and each having a single different colored phosphor material on the CRT faceplate. These CRT's are referred to as the red, green and blue CRT, respectively. Each separate colored raster image is optically amplified by a lens and projected to a screen for viewing. In the case of a rear projection television receiver, the separate colored raster images amplified by the lenses are projected via a mirror onto the rear of a translucent screen for viewing.

The electron beam of each CRT is controlled by a separate main deflection yoke and an auxiliary yoke, called the convergence yoke, mounted on the neck of each CRT. However, the three projected images do not overlap each other on the viewing screen. This is due to the three different light paths over which the three separate images travel from the respective CRT faces to the screen. To correct this mis-convergence, currents are produced by convergence circuitry which drive the respective convergence yokes. The resulting magnetic field produced by the convergence yokes both aids and opposes the main deflection yoke field.

The three CRT's of a PTV are typically positioned side by side, on a horizontal axis. By convention, the green CRT is positioned in the middle, and the red and blue CRT's are positioned outboard of the green CRT. Furthermore, the red and blue CRT's are slightly angled so that they point at an inward angle toward the green CRT. This arrangement, coupled with the different light paths of the three colored images, results in that the images of the red and blue CRT's will be projected on the viewing screen at a different angle than the green CRT image, resulting in a distortion of the displayed red and blue images. To help correct this distortion, the raster images of the blue and red CRT's are shifted in the horizontal direction on the face of the blue and red CRT's in a direction that is away from the green CRT. As each deflection beam of each CRT moves in the same direction when scanning a raster, this shift is opposite in polarity for the red and blue CRT's.

There are four methods to accomplish this horizontal raster centering shift: (1) passing a direct current through the red and blue horizontal yoke windings; (2) passing a direct current through the horizontal windings of the red and blue auxiliary convergence yokes; (3) shifting the red and blue rasters using centering magnet rings positioned so as to encircle the necks of the red and blue CRT's; and (4) any combination of methods (1), (2) and (3).

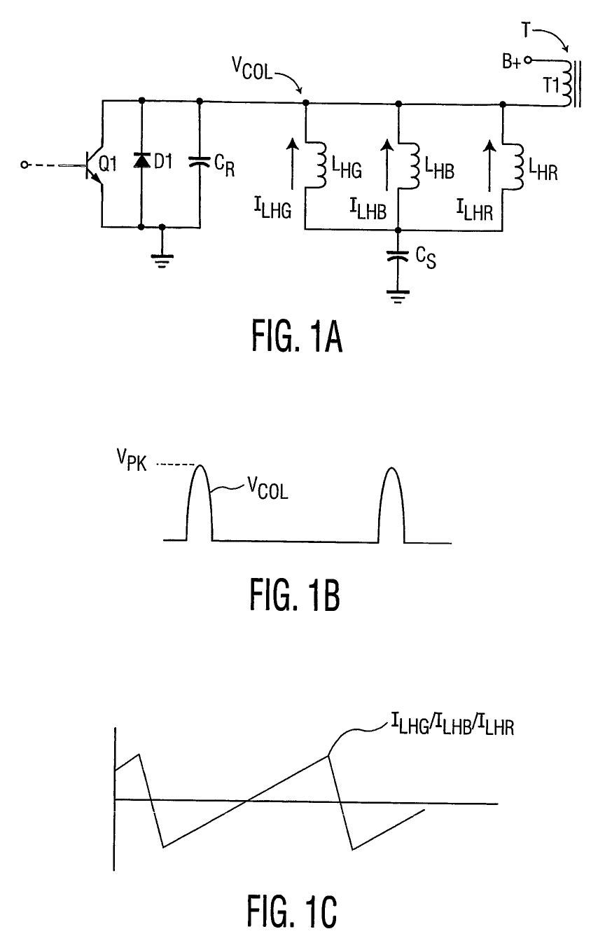

FIG. 1A shows a simplified schematic diagram for the horizontal deflection circuit of a typical PTV without any raster centering circuits. Transistor Q1 is the horizontal output transistor and operates as a switch, driven at a frequency of 31.5 kHz by circuitry (not shown) which synchronizes the switching operation of transistor Q1 so that the resulting generated raster is timed correctly with the incoming video signal. Diode D1 is a damping diode, and capacitor C_{R} is a retrace capacitor. Windings L_{HG}, L_{HB} and L_{HR} are the respective horizontal windings of the green blue and red deflection yokes positioned on the neck of each of the three respective color CRT's. Capacitor C_{S} is the S-shaping capacitor and winding T1 is the primary winding of a scan transformer T. In operation, transistor Q1 is initially off and capacitor C_{S} is charged to the level of the supply voltage B+. There is no current in windings L_{HG}, L_{HB} or L_{HR} and, hence, the electron beam is at the center of the CRT. Transistor Q1 then conducts as a low resistance switch and current flows from capacitor C_{S} through each deflection yoke in a linearly increasing manner and then through transistor Q1 to ground. The three electron beams are deflected from the center of the respective CRT to the right edge. The horizontal driver circuitry then turns transistor Q1 off. The inductive currents flowing in each yoke (as well as the current flowing in winding T1) will then flow into the horizontal retrace capacitor C_{R} charging it to a high value (V_{PK}) in a short period of time, as shown in FIG. 1B. The equivalent inductance of the parallel values of windings L_{HG}, L_{HB}, L_{HR} and T1 forms a high Q resonant circuit with capacitor C_{R}. As the current in the three deflection yokes is now decreasing in amplitude, the electron beams are quickly moved from the right side of the CRTs to the center. Capacitor C_{R} now discharges quickly through the deflection yokes in the opposite direction and the electron beams continue moving all the way to the left sides of the CRT's. This period of capacitor C_{R} charging and discharging is called the horizontal retrace time interval during which the video circuitry reduces the intensity of the electron beam so that it is not visible. During horizontal retrace, damper diode D1 is reverse biased. When capacitor C_{R} completely discharges, the voltage at the top of capacitor C_{R} tries to go negative thus forward biasing diode D1. Diode D1 then conducts the current in the deflection yokes back to capacitor C_{S} in a linearly decreasing manner, and hence, the electron beams move from the left sides of the CRT's back to the center. The cycle then repeats. Hence, ramp-shaped current waveforms I_{LHG}, I_{LHB} and I_{LHR} are produced, respectively, in each horizontal deflection yoke as shown in FIG. 1C. The capacitance value of capacitor C_{S} is chosen so that the ramp of current in it produces a parabolic voltage waveform across capacitor C_{S}. This parabolic voltage waveform is used to slightly modify the ramp of current in each deflection yoke causing it to be “S shaped” to compensate for the flatness of the CRT faceplate. The presence of capacitor C_{S} also effectively prevents any direct current from flowing through each yoke.

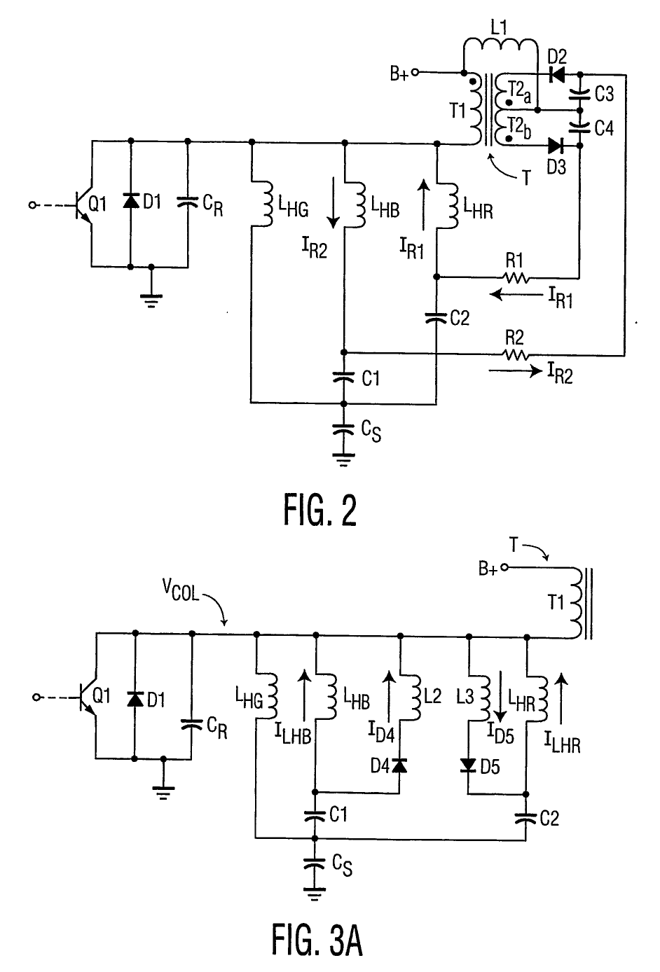

FIG. 2 shows a schematic diagram of one method for obtaining a DC current flow through windings L_{HB} and L_{HR} to shift the red and blue rasters. A “floating” dual DC power supply is formed by inductor L1 diodes D2 and D3, capacitors C3 and C4, and a tapped secondary winding T2ₐ/T2_{b} of the scan transformer T. This arrangement produces two DC voltages that are typically 10 volts higher and 10 volts lower than the B+ supply level. Hence, the DC voltage at the junction of diode D2 and capacitor C3 will be 10 volts below the level of the B+ supply voltage, and DC voltage at the junction of diode D3 and capacitor C4 will be 10 volts above the level of the B+ supply voltage. It should be noted that in FIG. 2, the average voltage at the top of the three deflection yokes is the B+ level, and that the average voltage drop across any winding of an inductor must be zero. Likewise, the average across windings L_{HB} and L_{HR} is zero so there will be 10 volts across resistors R1 and R2. This results in a direct current, designated I_{R1}, through resistor R1 and a direct current, designated I_{R2}, in resistor R2. These direct currents must flow through windings L_{HB} and L_{HR}, respectively, due to the DC blocking action of capacitors C1 and C2. The direct currents flowing through windings L_{HB} and L_{HR} result in the respective rasters being shifted on the face of the blue and red CRT's in opposite directions relative to each other. Inductor L1 is required because simply connecting the junction of capacitors C3 and C4 to the B+ supply would short out the desired action of capacitor C_{S}.

However, the raster centering circuit configuration of FIG. 2 is not without it's problems. One problem is the relatively high number of components required. Also, since the scan transformer T is used to form the two floating power supplies, it required three pins. Often, there are not enough extra pins available on the scan transformer T in that several other voltage supplies needed for operation of the PTV are developed from windings on transformer T. Because of their floating nature, the supplies formed in FIG. 2 cannot be used in other circuit areas of the PTV. The temperature stability of the centering currents is also a concern. The level of direct current which causes the raster shift is determined by the level of the DC voltages developed across capacitors C3 and C4, the resistance value of resistors R1 and R2, and to a lesser extent, the resistances of inductor L1 and windings T1, L_{HB} and L_{HR}.

The DC voltages developed across capacitors C3 and C4 are dependent on the forward voltage drop of diodes D2 and D3. It is well known that diodes exhibit a forward voltage drop that is dependent upon temperature. This results in the DC voltage developed across capacitors C3 and C4 being temperature sensitive. The exact resistance values of resistors R1, R2 and the resistances of inductor L1 and windings T1, L_{HB} and L_{HR} will also be dependent upon temperature. The end result is that the direct raster centering current varies with temperature. This results in the red and blue rasters becoming shifted with respect to the green raster, thereby causing a misalignment of the colored images on the screen.

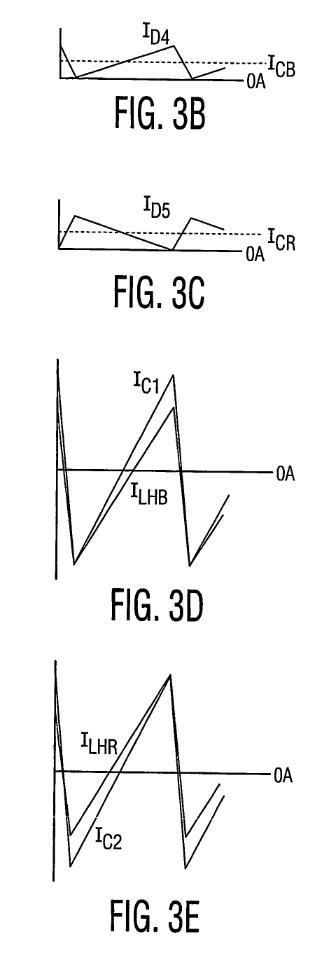

An improvement of the raster centering circuit of FIG. 2 is shown in FIG. 3A. Inductor L2 and diode D4 are added across the blue horizontal deflection yoke L_{HB}, and inductor L3 and diode D5 are added across the red horizontal deflection yoke L_{HR}. Inductors L2 and L3 integrate the pulse waveform at the collector of diode D1 to produce ramp shaped currents, I_{D4} and I_{D5}, respectively. Because of the presence of diodes D4 and D5, currents I_{D4} and I_{D5} are clamped to zero, as shown in FIGS. 3B and 3C. As in FIG. 2, capacitors C1 and C2 must also be added to the horizontal deflection circuit to AC couple windings L_{HB} and L_{HR} thereby allowing direct currents to be injected into windings L_{HB} and L_{HR} without disturbing any other circuits.

The circuit operation of FIG. 3A can be explained by noting that the instantaneous sum of the currents in winding L_{HB} and diode D4 will equal the current in capacitor C1. In other words, I_{LHB}+I_{D4}=I_{C1}. Likewise, I_{DS}+I_{C2}=I_{LHR}. At the beginning of horizontal scan, when the electron beam is at the left side of the CRT face, the current in the blue horizontal yoke, I_{LHB}, is equal to the current in capacitor C1, as the current in diode D4 is zero. As the electron beam is moved across the face of the CRT, the current in winding L_{HB} is reduced by the amount of current flowing in diode D4. As the average value of the current flowing in capacitor C1 must be zero, this causes the current I_{LHB} to become non-symmetrical, as shown in FIG. 3D. This results in the raster on the face of the blue CRT being shifted to the left. At the beginning of horizontal scan when the electron beam is at the left side of the CRT face, the current in the red horizontal yoke, I_{LHR}, is equal to I_{C2} less I_{D5}. As the electron beam is moved across the face, the current I_{LHR} is increased as the current I_{D5} in diode D5 is gradually reduced to near zero at the end of scan. As the average value of the current flowing in capacitor C2 must be zero, this causes the current I_{LHR} to become non-symmetrical, as shown in FIG. 3E. This results in the raster on the face of the red CRT being shifted to the right.

One can also explain the circuit action of FIG. 3A by noting that as a result of diodes D4 and D5, currents I_{D4} and I_{D5} are effectively AC waveforms with a DC value, called I_{CB} and I_{CR}, respectively. Although the AC component of the I_{D4} and I_{D5} currents will flow through capacitors C1 and C2, respectively, the DC components I_{CB} and I_{CR} must flow through windings L_{HB} and L_{HR}, respectively, producing the desired raster shift. The level of this raster shift, with respect to the green yoke current, is I_{CB} for the blue yoke and I_{CR} for the red yoke. The level of the raster shift is adjusted by the inductance values of inductors L2 and L3. A smaller value of inductors L2 and L3 results in a higher level of I_{CB} and I_{CR} and an increased amount of raster shift.

The temperature performance of the raster centering circuit in FIG. 3A is improved over that of the circuit in FIG. 2 in that the level of I_{CB} or I_{CR} is determined by just the inductance value of inductors L2 or L3, respectively, and not the resistances of inductors L2 or L3, or windings L_{HB} or L_{HR}. The forward voltage drop of diodes D4 and D5 do not contribute to the levels of I_{CB} and I_{CR} as the voltage pulse at the collector of diode D1 is several hundred volts. Hence, any change in the level of the forward voltage drop of diodes D4 or D5 in FIG. 3A is swamped out. By a careful selection of the magnetic cores material of inductors L2 and L3, it is possible to design them for a negligible inductance change with temperature.

An object of the invention is to provide a horizontal raster centering circuit in a line deflection circuit for a projection television receiver which is economical to produce, produces negligible power dissipation, and exhibits temperature stability.

This object is achieved in a horizontal deflection circuit for driving red, blue and green horizontal deflection coils of red, blue and green cathode ray tubes, respectively, in a projection television receiver, said horizontal deflection circuit comprising a high voltage supply, a line inductance coil coupled on one side to receive the high voltage from the high voltage supply, a switch for selectively coupling another side of said line inductance coil to ground, a parallel arrangement of a damping diode and a retrace capacitor coupled across said switch, said red, green and blue deflection coils each having a first end coupled to said another side of said line inductance coil and a second end; and capacitance means for coupling said second ends of said red, green and blue deflection coils to ground, wherein said horizontal deflection circuit further comprises a circuit for effecting horizontal centering of display rasters generated by said red, green and blue cathode ray tubes, said horizontal centering circuit comprising an inductance coil having a first end and a second end, means for coupling the first end of said inductance coil to said another side of said line inductance coil, a series arrangement of a first and second diode interconnecting the second ends of said red and blue deflection coil, a junction point between said first and second diodes being connected to the second end of said

inductance coil, and said capacitance means having capacitor means for coupling the second ends of at least said red and blue deflection coils to a connection node, and S-shaping capacitor means for coupling said deflection node to ground.

Arranged as such, the subject invention exhibits numerous benefits when compared to the prior art configuration of FIG. 2. In particular, the total number of components needed to produce the desired raster shifts is much less, resulting in a lower cost, more reliable circuit that required less printed circuit board area. In addition, there are no resistors in the centering circuit of the subject invention, and as such, the centering circuit produces little power dissipation in operation. The temperature stability of the centering circuit of the subject invention is much improved over that of the prior art circuit shown in FIG. 2. In particular, in the prior art circuit of FIG. 2, the DC raster shift currents are determined by the voltages across capacitors C3 and C4, and primarily by the resistors R1 and R2, all of which are parameters that will vary with the operating temperature of the projection television receiver. In the centering circuit of the subject invention, the DC raster shift currents depend primarily on the inductance value of the inductance coil. By carefully selecting the magnetic core material of the inductance coil, it is possible to design the inductance coil for a negligible inductance change with temperature.

The centering circuit of the subject invention accomplishes the same results as the prior art circuit of FIG. 3A. However, it should be noted that the centering circuit of the subject invention only requires the single induction coil as opposed to the dual inductors L2 and L3 shown in FIG. 3A.

With the above and additional objects and advantages in mind as will hereinafter occur, the subject invention will be described with reference to the accompanying drawings, in which:

FIG. 1A shows a schematic diagram of a known horizontal deflection circuit for a CRT projection television receiver;

FIGS. 1B and 1C show waveforms of the voltage across the retrace capacitor and the currents through the horizontal deflection yokes of the CRT's;

FIG. 2 shows a schematic diagram of another known horizontal deflection circuit with raster centering circuitry;

FIG. 3A shows a schematic diagram of another known horizontal deflection circuit with raster centering circuitry;

FIGS. 3B and 3C show waveforms of the currents through the diodes D4 and D5, FIG. 3D shows waveforms of the currents through the blue deflection yoke and its capacitor C1, and FIG. 3E shows waveforms of the currents through the red deflection yoke and its capacitor C2;

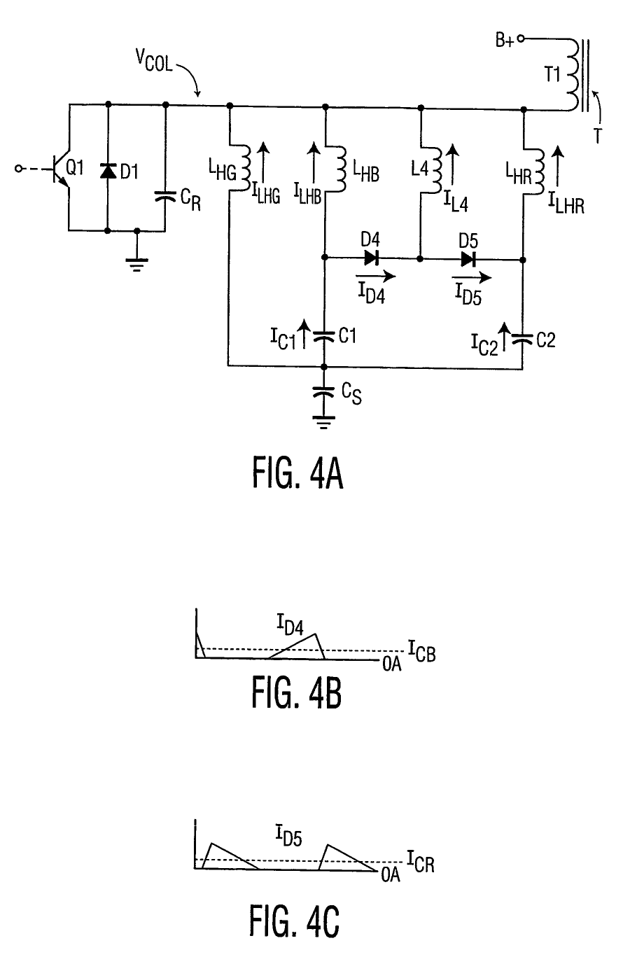

FIG. 4A shows a schematic diagram of a first embodiment of a horizontal deflection circuit with raster centering circuitry of the subject invention;

FIGS. 4B and 4C show waveforms of the currents through the diodes D4 and D5, FIG. 4D shows waveforms of the currents through the blue deflection yoke and its capacitor C1,

FIG. 4E shows waveforms of the currents through the red deflection yoke and its capacitor C2, FIG. 4F shows a waveform of the current through the inductor L4, and FIG. 4G shows waveforms of the currents through each of the red, green and blue deflection yokes;

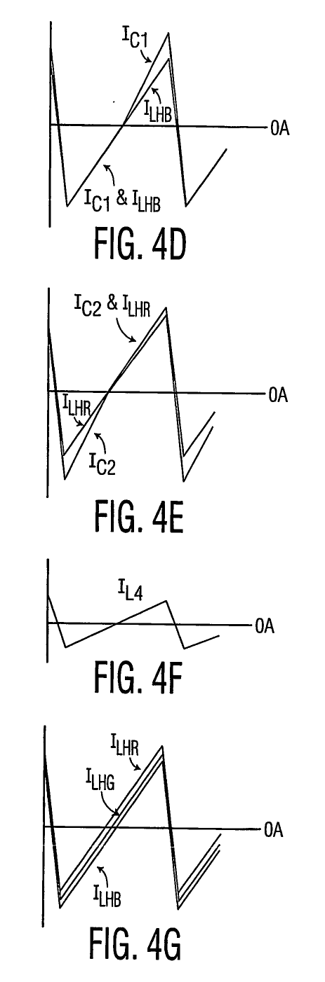

FIG. 5 is a schematic diagram of a second embodiment of the horizontal deflection circuit with raster centering circuitry of the subject invention;

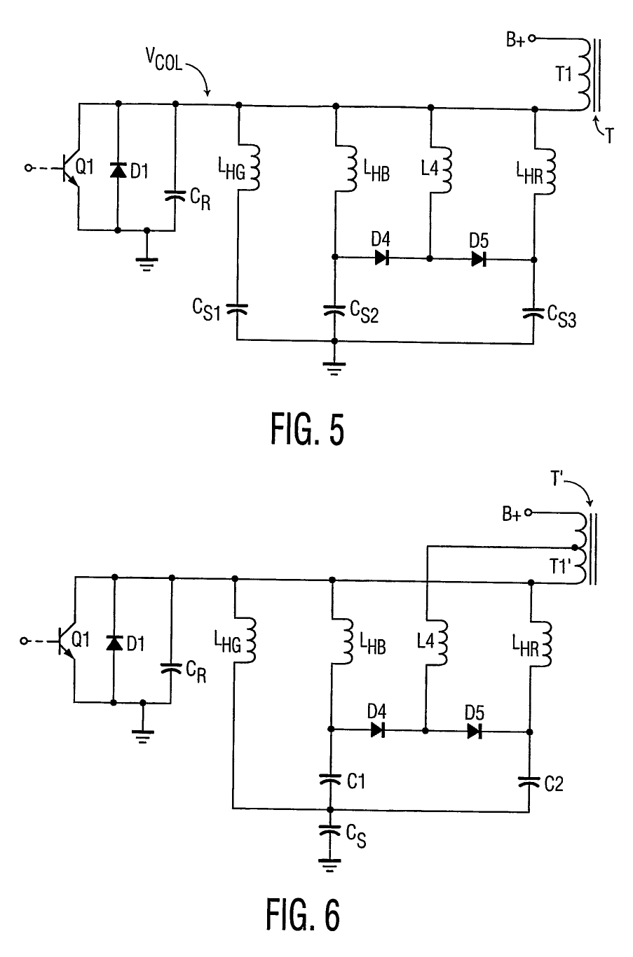

FIG. 6 is a schematic diagram of a third embodiment of the horizontal deflection circuit with raster centering circuitry of the subject invention; and

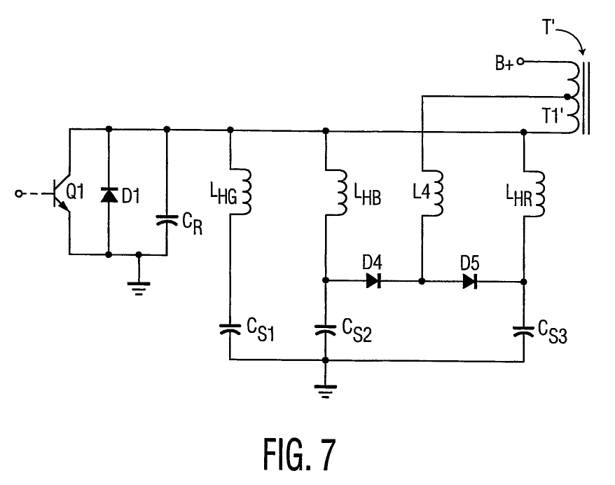

FIG. 7 is a schematic diagram of a fourth embodiment of the horizontal deflection circuit with raster centering circuitry of the subject invention.

Similarly as in FIGS. 1A, 2 and 3A, in the horizontal deflection circuit of the subject invention as shown in FIG. 4, transistor Q1 is the horizontal output transistor and operates as a switch driven at a frequency of 31.5 kHz for synchronizing the switching operation of transistor Q1 with the incoming video signal. Damping diode D1 and retrace capacitor C_{R} are arranged across the emitter and collector of transistor Q1. The supply voltage B+ is applied to one end of the primary winding T1 of scan transformer T, the other end of which is connected to the collector of transistor Q1.

The green deflection yoke LHG has one end connected to the collector of transistor Q1 and the other end connected to ground via S-capacitor CS. The blue deflection yoke LHB has one end connected to the collector of transistor Q1 and the other end connected through a capacitor C1 to the capacitor CS. Similarly, the red deflection yoke LHR has one end connected to the collector of transistor Q1 and the other end connected through a capacitor C2 to the capacitor CS. The junction between yoke LHB and capacitor C1 is connected to the junction between the yoke LHR and capacitor C2 by the series arrangement of two diodes D4 and D5. An inductor L4 connects the collector of transistor Q1 to the junction between the two diodes D4 and D5. The inductor L4 replaces the inductors L2 and L3 of the circuit of FIG. 3A and has a value of approximately one-half the inductance value of inductors L2 and L3 in order to achieve the same level of raster shift as the circuit in FIG. 3A. The current in inductor L4 is produced by the integration of the voltage signal at the collector of Q1. Because either diode D4 or diode D5 is conducting, and capacitors C1 and C2 are large in value, this integration produces a current in L4 that is both ramp-shaped and continuous, and has no DC component, as is shown in FIG. 4F. Unlike in the operation of the circuit in FIG. 3a, diodes D4 and D5 conduct for only half the time, as shown in FIGS. 4B and 4C.

During the first half of horizontal scan when the electron beams are moving from the left sides of the respective CRT faces to the centers, only diode D5 is forward biased and conducting, while diode D4 is not forward biased and, as such, not conducting. The current I_{LHR} in the red horizontal yoke L_{HR} is equal to the current I_{C2} through capacitor C2 less the current I_{D5} through the diode D5. As the red electron beam is moved across the CRT to the center, diode D5 turns off and then, for the second half of scan, current I_{C2} is equal to the red horizontal yoke current I_{LHR}, as diode D5 is zero. As the average value of the current flowing in capacitor C2 must be zero, this causes the current I_{LHR} to become non-symmetrical, as shown in FIG. 4E. This results in the raster on the face of the red CRT being shifted to the right. During the second half of horizontal scan when the red electron beam is moving from the center of the CRT face to the right edge, only diode D4 is forward biased and conducting while diode D5 is not forward biased and, consequently, not conducting. The current I_{LHB} in the blue horizontal yoke L_{HB} is equal to the current I_{C1} through the capacitor C1 less the current I_{D4} through the diode D4. During the first half of horizontal scan when the blue electron beam is moving from the left side of the CRT face to the center, diode D4 turns off and, as such, the current I_{C1} is equal to the current I_{LHB} as the current I_{D4} is zero. As the average value of the current flowing in capacitor C1 must be zero, this causes the current I_{LHB} to become non-symmetrical, as shown in FIG. 4D. This results in the raster on the face of the blue CRT being shifted to the left.

Current I_{D5}, as shown in FIG. 4C, is a pulsating AC waveform with a direct current component value I_{CR}. Although5 the AC component of current I_{D5} will flow through capacitor C2, Direct current I_{CR} must flow though the red horizontal deflection yoke L_{HR}, in the direction shown in FIG. 4A thereby producing the desired raster shift. Because of the presence of capacitor C2, direct current I_{CR} is confined to the loop formed by inductor L4, diode D5 and winding L_{HR}. Although diode D5 only conducts for half the scan time, capacitor C2 is charged and discharged so that during the second half of the scan, direct current I_{CR} remains continually flowing. Capacitor C2 acts together with the winding L_{HR} and smoothes the pulsating current I_{D5} into the direct current I_{CR}.

Current I_{D4}, shown in FIG. 4B, is a pulsating AC waveform with a direct current component value I_{CB}. Although the AC component of current I_{D4} will flow through capacitor C1, the direct current I_{CB} must flow though the blue horizontal deflection yoke L_{HB} in the direction shown in FIG. 4A producing the desired raster shift. Because of the presence of capacitor C1, the current I_{CB} is confined to the loop formed by inductor L4, diode D4 and winding L_{HB}. Although diode D4 only conducts for half the scan time, capacitor C1 is charged and discharged so that, during the second half of scan, current I_{CB} remains continually flowing. Capacitor C1 acts together with winding L_{HB} and smoothes the pulsating current I_{D4} into the direct current I_{CB}.

FIG. 4G shows waveforms of the blue and red horizontal yoke currents I_{LHB} and I_{LHR} displayed with the green horizontal yoke current I_{LHG} which has no raster centering correction current. It should be noted that the blue and red horizontal yoke currents I_{LHB} and I_{LHR} are displaced from the green horizontal yoke current I_{LHG} by an amount equal to the currents I_{CB} and I_{CR}.

The level of desired raster shift is determined by the inductance value of inductor L4. To achieve an increased raster shift, the inductance value of inductor L4 must be lowered. To reduce the amount of raster shift, the inductance value of inductor L4 must be increased. It should be noted that diodes D4 and D5 switch at a time when the current through them is zero, greatly reducing any radio frequency EMI produced.

The desired action of the raster shifting circuit shown in FIG. 4A may be implemented in alternate embodiments that are slight modifications to the FIG. 4A circuit. In the embodiment of FIG. 5, capacitors C1 and C2 of FIG. 4A have been replaced by capacitors C_{S2} and C_{S3}. In addition, capacitor C_{S} has been removed and now capacitor C_{S1} has been placed in series with the horizontal winding of the green CRT yoke L_{HG}. The capacitance values of capacitors C_{S1}, C_{S2} and C_{S3} are equal to each other and are equal to the capacitor C_{S} of FIG. 4A divided by three. This may be desirable from a cost viewpoint as the capacitors C2 and C2 must have a large capacitance value and must be able to carry the entire horizontal deflection yoke current. Hence, a large electrolytic type construction capacitor would have to be used. Capacitors C_{S1}, C_{S2} and C_{S3} are smaller in physical size and value, so a lower cost plastic film type capacitor may be utilized.

In another embodiment, as shown in FIG. 6, the top of inductor L4 is returned to a tap off winding T1′ of the scan transformer T, instead of the collector of transistor Q1. By doing this, the pulse voltage at the tap of winding T1′ is smaller in amplitude than the pulse voltage at the collector of transistor Q1. Although the inductance of inductor L4 must be reduced to achieve the same degree of raster shift of FIG. 4A, the end result is that the volt-seconds product of the voltage waveform across inductor L4 is reduced, and inductor L4 can be made physically smaller in size and lower in cost. Care must be utilized in the design of a circuit using the

topology of FIG. 6, in that as the tap position is moved closer to B+ terminal of winding T1′, the value of inductor L4 must be further reduced and it will begin to counteract the desired effects of C_{S}, the S-shaping capacitor. In addition, the ramp of current in inductor L4 of FIG. 6 has a higher degree of S-shaping than the inductor L4 current of FIG. 4A. This will influence the DC level of the currents flowing in diodes D4 and D5 of FIG. 6.

Finally, in yet another embodiment of the invention, as shown in FIG. 7, the features of the embodiments shown in FIGS. 5 and 6 are combined.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

1. A horizontal deflection circuit for driving red, blue and green horizontal deflection coils (L_{HG}, L_{HB}, L_{HR}) of red, blue and green cathode ray tubes, respectively, in a projection television receiver, said horizontal deflection circuit comprising:
a high voltage (B+) supply;
a line inductance coil (T1) coupled on one side to receive the high voltage (B+) from the high voltage supply;
a switch (Q1) for selectively coupling another side of said line inductance coil (T1) to ground;
a parallel arrangement of a damping diode (D1) and a retrace capacitor (C_{R}) coupled across said switch (Q1);
said red, green and blue deflection coils (L_{HG}, L_{HB}, L_{HR}) each having a first end coupled to said another side of said line inductance coil (T1) and a second end; and
capacitance means (C_{S}, C₁, C₂) for coupling said second ends of said red, green and blue deflection coils (L_{HG}, L_{HB}, L_{HR}) to ground,
wherein said horizontal deflection circuit further comprises a circuit for effecting horizontal centering of display rasters generated by said red, green and blue cathode ray tubes, said horizontal centering circuit comprising:
an inductance coil (L4) having a first end and a second end;
means for coupling the first end of said inductance coil to said another side of said line inductance coil (T1);
a series arrangement of a first and second diode (D4, D5) interconnecting the second ends of said red and blue deflection coil (L_{HB}, L_{HR}), a junction point between said first and second diodes (D4, D5) being connected to the second end of said inductance coil (L4); and
said capacitance means having capacitor means (C₁, C₂) for coupling the second ends of at least said red and blue deflection coils (L_{HB}, L_{HR}) to a connection node, and S-shaping capacitor means (C_{S}) for coupling said deflection node to ground.

2. The horizontal deflection circuit as claimed in claim 1, wherein said capacitance means comprises a first capacitor (C₁) connecting the second end of said blue deflection coil (L_{HB}) to said connection node, a second capacitor (C₂) connecting the second end of said red deflection coil (L_{HR}) to said connection node, and an S-shaping capacitor (C_{S}) for connecting said connection node to ground.

3. The horizontal deflection circuit as claimed in claim 1, wherein said capacitance means comprises a first capacitor (C_{S2}) connecting the second end of said blue deflection coil (L_{HB}) to said connection node, a second capacitor (C_{S3}) connecting the second end of said red deflection coil (L_{HR}) to said connection node, and a third capacitor (C_{S1}) connecting the second end of said green deflection coil (L_{HR}) to said connection node, said connection node then being connected to ground, wherein said first, second and third capacitors (CS₂, CS₃, C_{S1}) include said S-shaping capacitor means (C_{S}), have equal values and are each equal to one-third of a capacitance value of said S-shaping capacitor means (C_{S}).

4. The line deflection circuit as claimed in claim 1, wherein said coupling means comprises:
said line inductance coil (T1′ ) being formed with a center tapping, said first end of said inductance coil (L4) being connected to said center tapping.

5. The line deflection circuit as claimed in claim 4, wherein said capacitance means comprises a first capacitor (C₁) connecting the second end of said blue deflection coil (L_{HB}) to said connection node, a second capacitor (C₂) connecting the second end of said red deflection coil (L_{HR}) to said connection node, and an S-shaping capacitor (C_{S}) for connecting said connection node to ground.

6. The horizontal deflection circuit as claimed in claim 4, wherein said capacitance means comprises a first capacitor (C_{S2}) connecting the second end of said blue deflection coil (L_{HB}) to said connection node, a second capacitor (C_{S3}) connecting the second end of said red deflection coil (L_{HR}) to said connection node, and a third capacitor (C_{S1}) connecting the second end of said green deflection coil (L_{HG}) to said connection node, said connection node then being connected to ground, wherein said first, second and third capacitors (C_{S2}, C_{S3}, C_{S1}) include said S-shaping capacitor means (C_{S}), have equal values and are each equal to one-third of a capacitance value of said S-shaping capacitor means (C_{S}).
